(19) United States
(12) Patent Application Publication
(10) Pub. No.: US 2002/0157103 A1
(43) Pub. Date: Oct. 24, 2002

(54) Method for digital media playback in a broadcast network

(76) Inventors: Deyang Song, Belmont, CA (US); Shoudan Liang, Palo Alto, CA (US)

Correspondence Address: Tarek N. Fahmi, BLAKELY, SOKOLOFF, TAYLOR & ZAFMAN LLP, 7th Floor, 12400 Wilshire Boulevard, Los Angeles, CA, 90025, US

(21) Appl. No.: 09/755,483

(22) Filed: Jan. 5, 2001

Related U.S. Application Data
(60) Provisional application No. 60/175,166, filed on Jan. 7, 2000.

(51) Int. Cl. H04N 7/173

(52) U.S. Cl. 725/97; 725/93; 725/101

(57) ABSTRACT

A multimedia presentation is divided into sequential segments, each segment having a time length, the transmission of the segments of the multimedia presentation is then scheduled according to a specified delay time that does not depend on the time lengths of the segments, and the segments are then transmitted over a broadcast network according to the schedule for each segment so computed. Preferably, a transmission bandwidth of multiple times that of the multimedia presentation is allocated for transmission of the segments and each segment is then transmitted repeatedly based on the computed schedule. In cases of conflict, later segments are scheduled earlier and thus transmitted more frequently than desired. Once transmitted, the segments may be received and stored in temporary storage, and then played back as soon as the delay time has elapsed.

### RELATED APPLICATION

The present application is related to and hereby claims the priority benefit of a U.S. Provisional Patent Application No. 60/175,166, entitled “Instant Digital Media Playback in a Broadcast Network,” filed Jan. 7, 2000, by Deyang Song and Shoudan Liang.

### FIELD OF THE INVENTION

The present invention relates to the field of digital broadcast networks such as digital cable television systems, digital terrestrial broadcast systems and/or digital satellite systems, and in particular to video-on-demand (VoD) broadcast systems, such as may be found in cable or satellite television broadcast systems and/or computer networks or networks of networks.

### BACKGROUND

For several years, operators of cable and satellite television broadcast systems (and more recently long distance network operators) have been promoting so-called video-on-demand (VoD) systems. In theory, these systems will allow end-users to request virtually any movie or other audio-video program from a library and have that movie or other presentation begin playback almost immediately. To date, however, the promise of such near-instantaneous playback has gone unrealized and, perhaps as a result, VoD systems have not yet been widely deployed.

Current VoD systems operate on familiar client-server principles. Movies and other audio-video programs are stored at one or more central locations (e.g., a cable or satellite television head-end system) and are played out as requested to one or more client devices (e.g., cable or satellite television receivers commonly called “set-top boxes”). Requests for movies may be made in various fashions, such as by utilizing a back channel between the client and the server across the transmission medium or through a separate channel such as a dial-up telephone connection. Upon receipt of a request for a program, the server typically opens a separate video stream to serve the new request. Thus, as more requests are received, more video streams are opened, up to a point.

One of the problems of current VoD systems that prevent such systems from being widely deployed is the scalability of the servers involved in such systems. Currently, each server can only support a predetermined number of viewers requesting on-demand movies. Because of these limitations, if additional requests for videos are received while the server is serving a maximum number of current viewers, the server is forced to reject the new requests, leaving the video consumers unsatisfied. For example, if the server is designed to support 1000 concurrent video streams, the 1001th request (and all those thereafter) will be rejected or at the very least delayed until one of the current viewers finishes his/her session.

This limitation on the number of streams that any one server can source is due, in part, to bandwidth constraints. At the server, movies are often stored as computer-readable files on hard disks, or other computer-readable media, in the well-known MPEG-2 format (Motion Picture Experts Group-2) or other format. During transmission, each MPEG-2 movie typically consumes a bandwidth ranging from 3-6 Mbps, depending upon the video quality, etc. Existing digital broadcast networks, however, typically utilize analog transmission channels. Take the digital cable network in the United States for example; each analog transmission channel occupies 6 MHz of radio frequency spectrum. Broadcast networks are required to divide up these available analog channels into segments in order to accommodate the transmission of digital movies. Depending on the modulation scheme, one 6 MHz analog channel can carry digital movies totaling 27 Mbps and up. If each movie is encoded at 4 Mbps, then each analog channel can carry at least 6 digital channels.

Given the limited amount of bandwidth to transmit digital movies, a VoD server can only serve a limited number of concurrent viewers using the traditional approach of one-stream-per-viewer. Using the above example, suppose each analog channel carries 6 digital channels, a conventional 100-channel cable system can thus only serve 600 viewers simultaneously. In order to serve a large number of home viewers then, a cable service provider would be forced to replicate the servers and the various movies many times over. This has been, to date, economically unfeasible and so VoD systems have not been deployed. Thus, an alternative scheme for VoD systems is needed.

### SUMMARY OF THE INVENTION

In one embodiment, a schedule for transmission times of various segments of digital content is computed to allow for transmission of these segments across multiple channels so as to permit any number of content consumers to begin playback of said segments of digital content from an origination point thereof within a waiting time of a request (the waiting time may be selectable by the content broadcaster) for such playback. These various segments of digital content together may make up a movie. These segments are preferably non-overlapping, and each of their sizes can be arbitrary, although quite often they are made equal length in time.

In some cases, the schedule is determined according to an earliest-deadline-first (EDF) process. In the EDF process, a next transmission time for a segment of digital content is determined by first finding an earliest deadline amongst a list of current deadlines for each of the various segments and selecting this segment for transmission. The earliest deadline so chosen may be verified to be later than a finishing time for a last transmitted segment. A new deadline for transmission of the selected segment may then be determined according to T+tₗ+t_{d}, where T is a beginning time for the transmission of the selected segment, t, is the playback time of segment i in the movie, and t_{d} is the waiting time at the receivers.

In other cases, the schedule may be determined according to a just-in-time (JIT) process. The JIT process schedules each of the various segments for transmission as close to a transmission deadline associated with each segment as possible. In the JIT process, conflicts for transmissions over the multiple channels are resolved by scheduling a segment with an earlier playback time closer to its deadline for transmission than a segment with a later playback time. Segments with later playback times may be rescheduled earlier in order to avoid conflict.

In still further cases, the schedule may be determined according to a periodic transmission process. Such a process allows a broadcast schedule for the movie to be repeated every period time, the period time being equal to an integral multiple of a length of the movie. In this scheme, each one of the multiple segments is allocated to a transmission queue of a transmission schedule table according to a number of times equal to the period time divided by the sum of the waiting time and a playback time for such segment.

A further embodiment provides a procedure wherein a multimedia presentation is first divided into sequential segments, each segment having a time length, the transmission of the segments of the multimedia presentation is then scheduled according to a specified delay time that does not depend on the time lengths of the segments, and the segments are then transmitted over a broadcast network according to the schedule for each segment so computed. Preferably, a transmission bandwidth of multiple times that of the multimedia presentation is allocated for transmission of the segments and each segment is then transmitted repeatedly based on the computed schedule. Once transmitted, the segments may be received and stored in temporary storage, and then played back as soon as the delay time has elapsed.

Each of the segments may be scheduled for repeated transmissions at periodic times. These periodic times for transmission of each respective segment may equal time offsets of the beginning of such respective segments plus an operator selected delay time. Segments having earlier transmission deadlines should be scheduled first and as soon as possible.

Alternatively, the segments may be transmitted just-in-time as determined by respective time offsets and the specified delay. In the case of a conflict where more of the segments are to be transmitted than allocated bandwidth allows, segments later in the presentation are scheduled to be transmitted earlier in nearest empty time slots, giving priority to earlier segments to be transmitted as closely as possible to their scheduled time slots. In some cases, an overlap period between an end of a current presentation and a beginning of a next presentation may also be computed, to minimize interruptions therebetween.

Still another embodiment provides a server configured to generate transmission schedules for each of a number of segments of a multimedia presentation to be transmitted over a multiple channels of a broadcast network, the schedules being computed according to a specified delay time that does not depend on time lengths of the segments. The transmission schedules are preferably computed according to one of a just-in-time transmission (JIT) procedure, an earliest-deadline-first (EDF) procedure, a hybrid of the EDT and JIT procedures, or a periodic transmission procedure. For the EDF procedure a next segment to be transmitted is determined by first finding an earliest transmission deadline amongst a list of current transmission deadlines for each of the segments and selecting this segment for transmission. For the JIT procedure each of the segments is scheduled for transmission as close to a transmission deadline associated with each segment as possible. For the hybrid procedure segments with the earliest deadlines are transmitted first, but the deadlines for each of the segments are computed conflict-free with the JIT procedure. For the periodic transmission procedure each of the segments is allocated to a transmission queue according to a schedule that takes into account a period of the presentation, the delay time and a playback time for each segment.

Yet another embodiment provides a receiver configured to receive segments of multimedia presentation from multiple transmission channels simultaneously and to begin playback of the segments in a sequence corresponding to a proper format for the multimedia presentation after a predetermined delay time that is independent of time lengths of the segments. The segments may be stored on a local storage medium and may be received according to a schedule that was computed according to one of a just-in-time transmission (JIT) procedure, an earliest-deadline-first (EDF) procedure, a combination thereof or a periodic transmission procedure.

### BRIEF DESCRIPTION OF THE DRAWINGS

The present invention is illustrated by way of example, and not limitation, in the figures of the accompanying drawings in which like reference numerals refer to similar elements and in which:

FIG. 1 is a schematic illustration of a digital broadcast system configured in accordance with an embodiment of the present invention.

FIG. 2 is a schematic illustration of a conventional method of dividing a multimedia presentation into non-overlapping segments.

FIG. 3 is a schematic illustration of the scheduled transmission of segments of a multimedia presentation in accordance with an embodiment of the present invention.

FIG. 4 is a schematic illustration of an embodiment of a periodic scheduling algorithm in accordance with an embodiment of the present invention.

FIG. 5 is a schematic illustration of queues that contain the segment indexes used in a periodic transmission scheme in accordance with an embodiment of the present invention.

FIG. 6 is a schematic illustration of how the next deadline for V, is computed in the Earliest-Deadline-First (EDF) scheduling algorithm in accordance with an embodiment of the present invention.

FIG. 7 is a schematic illustration of how scheduling conflicts are resolved in the Just-In-Time scheduling algorithm in accordance with an embodiment of the present invention.

### DETAILED DESCRIPTION

Described herein is a scheme in which a multimedia presentation (e.g., a digital movie) is divided into small segments and those segments are broadcast periodically using multiple channels following a pre-computed schedule. Such a scheme may find application, for example, in a broadcast system for cable television or a satellite television broadcast system. Other areas where the present invention may find application include computer networks or networks of networks, such as the Internet or any other area where audio-video presentations are intended for “on-demand” style presentation.

The present scheme exploits the idea that many viewers may wish to view the same movie or other content, but at different times. For example, it is likely that many viewers will wish to view so-called “first run” movies or other popular content, but that they will want to schedule such viewings at individual times convenient for themselves. Thus, when serving a large number of viewers, a VoD server is, at any particular time, very likely to be serving the same movie to many viewers who started the playback at different times.

By exploiting this idea, the present method allows all the viewers watching the same movie to use a fixed amount of the available bandwidth for the broadcast system (usually just a few multiples of the bandwidth required for one movie). This helps to “scale up” VoD servers in large-scale deployments. That is, by eliminating the necessity for the server to consume the same bandwidth for each instance of a movie or other content being broadcast in response to a client request, the present method allows broadcasters to free up this bandwidth for other uses (e.g., additional requests for content).

In addition to allowing for greater economies of scale, the present scheme provides for near-instantaneous playback of requested movies or other content. That is, a client (e.g., a digital set-top-box with a certain amount of local storage capacity in the form of a computer-readable/writeable medium, preferably of up to one movie length), when tuning to a selected presentation will be able to play back that presentation from its beginning after a very short waiting time. The waiting time is adjustable and it is expected to range from 1 to 30 seconds, depending on the number channels allocated to a particular presentation. In one embodiment, where 6 MPEG-2 channels are allocated for each movie, a user can tune in to a movie at any time and need only wait a maximum of approximately 30 seconds for the movie to begin playing from its beginning.

Although discussed with reference to certain illustrated embodiments, upon review of this specification, those of ordinary skill in the art will recognize that the present scheme for VoD broadcast and/or digital broadcast networks may find application in a variety of systems. Therefore, in the following description the illustrated embodiments should be regarded as exemplary only and should not be deemed to be limiting in scope. Instead, the reader is directed to the claims at the end of this specification, which claims more clearly define the present invention. Further, some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities.

The symbols used in the algorithms presented herein have the following meanings:

B data-rate of one movie

Cₖ channel k

d delay factor

D[i] the next deadline for the i-th segment

δᵢ the transmission time of the i-th segment

i segment index

k channel index

L[i] the proposed (future) schedule time for segment i.

m # of channels

n # of segments

sᵢ the i-th segment length (in time)

S[ ] the scheduling table

tᵢ playback time for the i-th segment

t_{d} the operator-selected maximum wait-time by the receiver

Tₚ the schedule period

Vᵢ the i-th segment

Further, unless specifically stated otherwise, it should be appreciated that throughout the description of the present invention, use of terms such as “processing”, “computing, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As indicated above, the present method allows for a potentially unlimited number of viewers to watch the same multimedia presentation transmitted over a digital broadcast network with a fixed amount of bandwidth allocation. Under the present scheme, each digital multimedia presentation (e.g., a movie or the like) is divided into segments of equal playback time or equal compressed transmission time. (In fact, the present methods will schedule any arbitrary division of a movie.) The total bandwidth allocated for the transmission of the multimedia presentation is divided into multiple channels, each of which having the bandwidth equal that of the multimedia presentation. A time-based schedule (which may be realized in a scheduling table stored as a computer-readable file at the server) is computed based on the total bandwidth allocated for the transmission and the segments of the presentations are then transmitted repeatedly in different channels according to the respective computed schedule. The frequency of their transmission, however, is different based on their relative location to the beginning of the presentation. The transmitted segments are first buffered and then reassembled by the receiver, preferably within a predetermined period of time. In practice, the receiver should be able to receive data from the multiple channels allocated to the broadcast of the rearranged segments of the multimedia presentation. This is feasible using transmission and reception hardware found in existing digital cable networks and direct broadcast satellite systems.

The present invention may be embodied in a system that includes a broadcast server that transmits the segments of a digital video according to the computed schedule, and a broadcast receiver that receives the transmitted segments and reassembles them into the original video. The receiver is assumed to have sufficient available temporary storage to buffer a number of segments of the movie, sufficient to permit the required reassembling. One embodiment of the present invention involves a software implementation of the above-described method, which implementation is independent of the particular hardware used in the broadcast network and/or the transmission system employed therein.

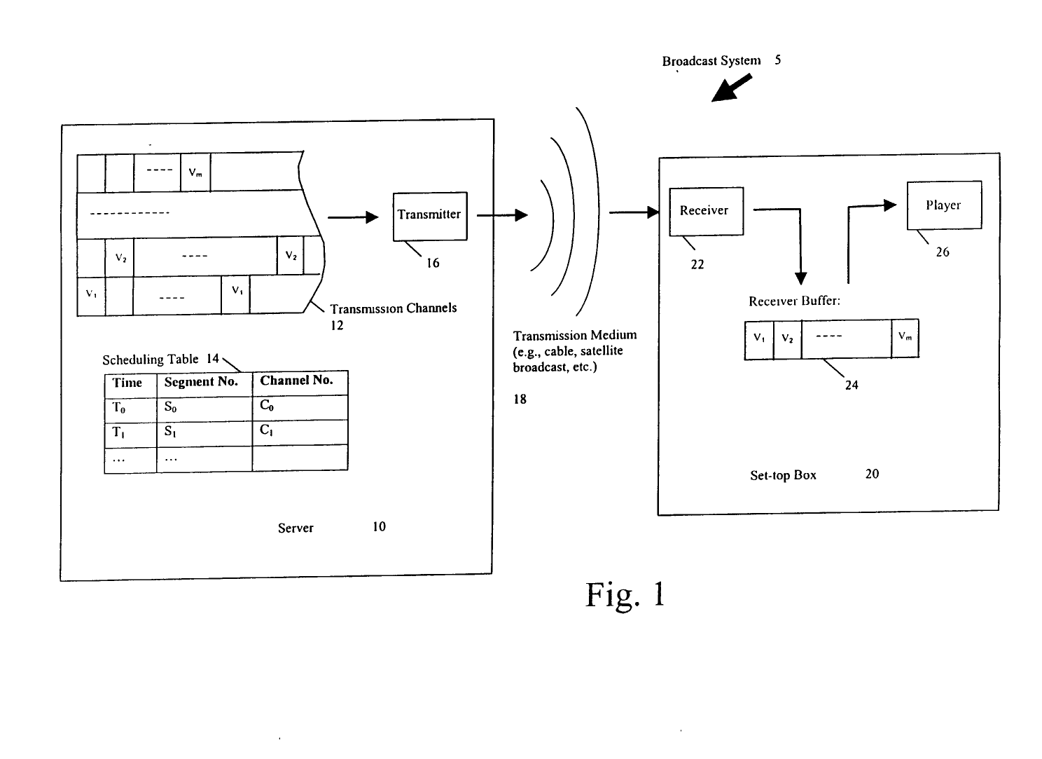

FIG. 1 schematically illustrates a broadcast system implementing one embodiment of the current invention. Broadcast system 5 includes a server 10 and a set-top box (or other form of receiving client) 20. It should be appreciated that set-top box 20 is merely one example of a number of receiving clients that may be part of broadcast system 5. It is expected that there may be hundreds or thousands (or more) of such receiving clients that together comprise a cable or satellite television distribution system. A single set-top box 20 is shown here merely for purposes of illustrating the systems and methods of the present invention and should not be deemed to limit the broader applicability of the present invention to much larger distribution systems. Not shown here is the Electronic Program Guide (EPG) that every set-to-box receives that provides, among other things, the mapping of movies to channels. Also not shown in the diagram is a back channel or other communication channel that may exist between the set-top box 20 and the server 10, which back channel may be used to communicate requests for on-demand movies, as an alternative for server-initiated broadcasting. Such back channels are well-known in the art and need not be described in detail herein.

The broadcast server 10 stores a number of movies and other audio-video presentations on local storage (not shown). For example, the server 10 may store such movies on a local hard drive or, more commonly, on a local series of storage media accessible as needed. These details are well-known in the art and need not be described further herein in order no to obscure the details of the present invention.

Server 10 transmits segments of a video or other presentation in channels 12 based on a computed schedule stored in a scheduling table 14. The diagram illustrates the idea of parsing up a presentation into a number of segments and then transmitting these segments in various time slots of a number of digital channels 12. The digital channels 12 may each be sub-channels of a wider analog channel as discussed above. Such multiplexing of digital content into sub-channels of an analog channel is also well-known in the art and may be performed in a modulator stage of a broadcast system and/or in the transmitter stage.

The transmitter 16 shown in the drawing need not necessarily be a separate component of broadcast system 5 or server 10 and is shown in block diagram form to represent a set of hardware and/or software components configured to transmit the segments of the presentation across the transmission medium 18 (which may be conventional cable television transmission media, satellite transmission media and/or a combination of these media types).

In some cases, the transmitter 16 may be implemented as a network interface card and a router in a data network, or a multiplexer, modulator and radio frequency (RF) transmitter. The transmission medium 18 may represent a data or other computer network or network of networks (such as the Internet), a digital cable network, or a Direct Broadcast Satellite (DBS) system. In short, the present invention may be utilized with any existing broadcast system configured to transport multimedia segments over multiple transmission channels.

Set-top box 20 is configured to receive the segments broadcast over transmission medium 18 and also to reassemble those segments into a proper form for playback. The set-top box 20 is shown as including a receiver 22, a receive buffer 24 and a player 26. In some embodiments, one or more of these components may be external to the set-top box 20. For example, player 26 may be incorporated in a television set or other playback device and/or in an external tuner or other module associated therewith. Receive buffer 24 may be a separate computer-readable medium, such as an external hard drive or the like, or may be included as a component of receiver 22 or player 26. In some cases, the receive buffer 24 may even be distributed between player 26 and receiver 22. Receiver 22 is configured to allow for user selection of a channel, i.e., one of the analog channels over which broadcast server 10 transmits. Receiver 22 receives data from the transmission medium 18 and saves the received data (one segment at a time) to receive buffer 24. Thereafter, player 26 may play back the stored segments, in sequence and perhaps at a specific time, for the user. Often, there will be some delay between reception of the segments and storage thereof at receive buffer 24 and playback through player 26. This delay time, which in some cases can be set by the user and/or the broadcast network operator, allows for proper sequencing of the segments and also guards against poor quality playback which may result from buffer underflows due to transmission errors.

Having thus presented the overall system within which the methods of the present invention operate, further details of the scheduling algorithms used to produce scheduling table 14 may be described. To understand the development of these algorithms, however, some further analysis of bandwidth requirements for the transmission of movies and other presentations is helpful.

The Analysis of Bandwidth Requirements

In conventional digital broadcast networks, such as cable, DBS, or High-Definition Television (HDTV) systems, multimedia presentations are often encoded, stored and transmitted as encoded digital video files. These files typically contain time-stamped, frame-by-frame compressed video and audio segments (sometimes called packets). Finding a particular segment then often involves searching for a time-stamp having the approximate desired time value (this is modified somewhat by the need in MPEG systems to also find the key frames that allow for reconstruction of a desired frame).

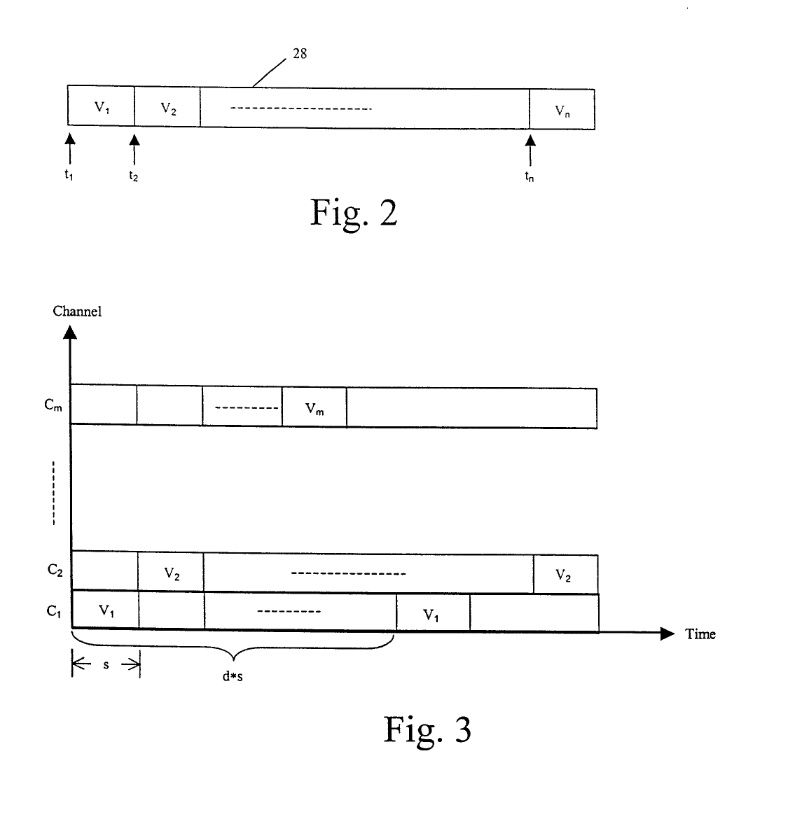

As shown in FIG. 2, a digital video file 28 of h hours at a data rate of B (bits/second) is divided into n segments, Vᵢ, i=1, 2, . . . n. Each segment contains “s” seconds of video data, where:

$$s = \frac{3600 h}{n} \qquad ( 1 )$$

Now, in accordance with the present scheme, each segment Vᵢ is broadcast repeatedly every (d+i−1)*s seconds, where d is a delay factor. These segments are broadcast using m channels, each channel having a bandwidth of B. The m channels may each be digital sub-channels of an analog channel. This broadcasting scheme is illustrated in FIG. 3.

If a receiver (e.g., receiver 22 in set-top box 20 of FIG. 1) can receive data from the m channels simultaneously, and it has access to local storage (e.g., receive buffer 24) that can store at least h hours of video, it can implement the VoD function with at most t_{d}=d*s seconds delay. In a digital broadband network, the m channels are equivalent to 1 channel with a total bandwidth of m*B. Thus, one needs to derive the smallest m required to support this scheme.

The bandwidth required to broadcast a segment Vᵢ is:

$${b}_{i} = \frac{1}{d + i - 1} B \qquad ( 2 )$$

Thus, the total bandwidth required to support an entire movie is:

$${b}_{tot} = {\sum }_{i = 1}^{n} {b}_{i} = B {\sum }_{i = 1}^{n} \frac{1}{d + i - 1} \qquad ( 3 )$$

An approximation for equation (3) is

$${b}_{tot} \approx B {\int }_{0}^{n} \frac{ⅆ x}{ⅆ + x} = B [ ln ( ⅆ + n ) - ln ( ⅆ ) ] \qquad ( 4 )$$

And m can then be calculated as following:

$$m = ⌈ \frac{{b}_{tot}}{B} ⌉ \approx ⌈ ln ( d + n ) - ln ( d ) ⌉ \qquad ( 5 )$$

For example, for a 2 hour movie divided into 5-second segments, n=1440. If the maximum delay time for beginning playback after a request has been made is to be 30 seconds, then d=6. Suppose the video data rate is 4 Mbps, then the total bandwidth required is bₜₒₜ≈22 Mbps. This will take, at most, 6 channels (m=6).

Note that in the above analysis, we assume that each movie segment is of equal length in time. If each segment has a different length sᵢ, equation (2) would become:

$${b}_{i} = \frac{{s}_{i}}{{t}_{i} + {t}_{d}} B \qquad ( 6 )$$

And the bandwidth requirement m can be similarly derived.

We describe below three different algorithms for broadcasting a movie over m channels repetitively.

The Earliest-Deadline-First Transmission Algorithm:

In this scheme, the i-th segment, at playback time tᵢ, has a transmission time δᵢ, which time depends on the movie and varies with the segments. Therefore, scheduling needs to be done on a case-by-case basis. An adjustable wait (or delay) time can optimally absorb any extra bandwidth turning it into a valuable resource. We seek the optimal wait time given a fixed number of channels.

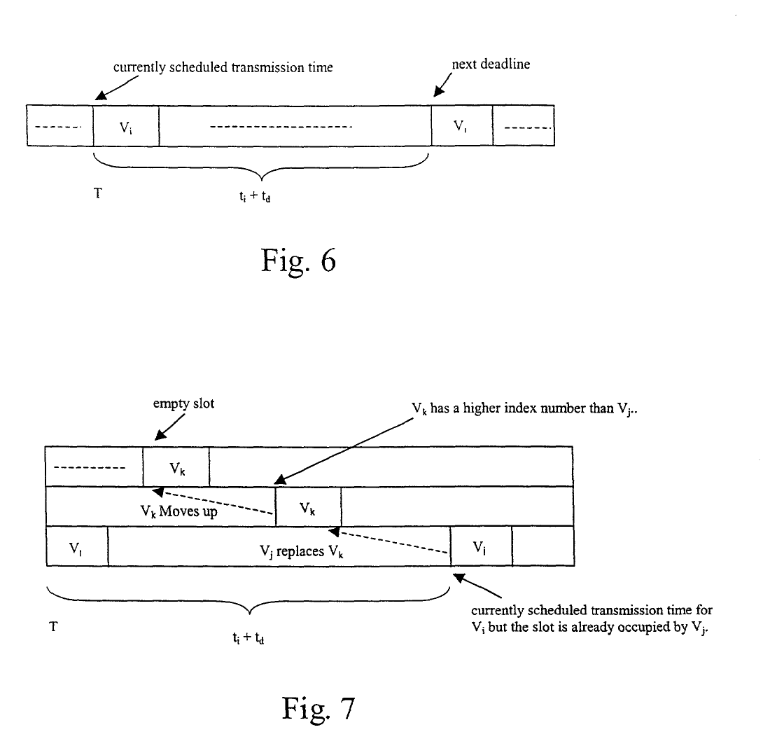

A viewer tuned in at time t generates n deadline demands for each of the n segments. On the broadcast server side, the deadline is defined as the time by which the segment must repeat itself. The segment Vᵢ has to be broadcast before t+tᵢ+t_{d}, where tᵢ is the playback time of segment i in the movie (see FIG. 2), and t_{d} is the waiting time by the receivers. This deadline definition is the same throughout all the scheduling algorithms presented herein, and is illustrated graphically in FIG. 6. We then seek a feasible broadcast schedule that meets the deadlines for any of the n segments Vᵢ for any connect time (i.e., the time at which a new user demands playback).

The available resources are time slots on the broadcasting channels. The present scheduling algorithm decides which of the n segments should be broadcast in the next available time slot/channel. For this earliest deadline first (EDF) policy, the segment Vᵢ having the shortest of the n deadlines is broadcast next. To accommodate such scheduling, one intermediate array is needed—the list of the earliest deadlines for each of the n segments, D[i]. We describe how to determine the optimal wait time and the algorithm also determines whether the wait time is feasible.

According to the present method, the video segment Vᵢ having the earliest deadline is scheduled to be transmitted next in the next available channel. Once segment Vᵢ is transmitted, we determine the deadline for the next Vᵢ transmission. If T is the time for the beginning of the last transmitted segment Vᵢ, the next transmit deadline for segment Vᵢ is set to T+tᵢ+t_{d}, since this is the earliest among the deadlines of all future time. (We assume the receiver is able to record a segment if it reads the header at the beginning of each segment.) We treat the m sub-channels as one channel with the m times the bit rate. δᵢ is the transmit time of segment Vᵢ on the single channel (equal to the size of Vᵢ divided by mB). Alternatively, we keep track of the finishing times on each channel of the last transmitted segment. The next available transmission slot is on the channel with the earliest finishing time. A simple scheme for actual implementation is as follows:

1. Suppose T is the current time. Find the earliest deadline amongst the current deadlines in the list D[i]; select this segment for transmission (earliest deadline first). Verify that the deadline chosen is no earlier than T. If not, the current schedule is unfeasible in which case the scheduling fails and the wait time needs to be increased.

2. If the deadline selected is no earlier than T, record or output the selected segment for transmission.

3. To update the next deadline D[i] after Vᵢ is broadcast the new deadline for transmitting the next Vi is given by T+tᵢ+t_{d} (see FIG. 6).

4. Increase T by δᵢ, the time needed for transmitting the video segment Vᵢ.

5. Repeat steps 1-4 until T reaches the end of the time allocated for broadcasting the movie.

In this scheme, D[i] is initialized to T₀+tᵢ+t_{d} when the broadcast begins at time T₀.

When a segment is scheduled before the deadline, all the future deadlines for this segment should be moved up. Therefore, scheduling a transmission before its indicated deadline costs resources in terms of bandwidth. An estimate of the “wasted” bandwidth is:

δ/(tᵢ+t_{d})B

where δ is the deadline less the current time, t_{d} is the delay, tᵢ is the beginning of the playback time for the i-th segment, and B is the transmission bandwidth. In an alternative method for scheduling, instead of choosing the earliest deadline, we pick the segment with the minimum δ/(tᵢ+t_{d}) in step 1.

The method described above computes a schedule from a predetermined deadline (or rejects the deadline if it is not feasible). We now discuss a method that optimizes the delay time. In this scheme we use the theorem proposed by Dertouzos (see M. L. Dertouzos, “Control robotics: the procedural control of physical processes” Information Processing vol. 74, 1974) that states: if a feasible schedule exists then the EDF process also produces a feasible schedule.

In this process, from the current schedule we reduce the wait time so that the new deadline is the actual realized schedule. Because the schedule is realized and therefore feasible, the EDF is also feasible. However, EDF will in general produce a different (and better) schedule. More specifically, if tₐ is the time when the segment Vᵢ is actually broadcast, we should have t+tᵢ+D′>tₐ, where D′ is the new deadline, and t is the time when the deadline was set (see the algorithm above). We have equivalently [t+tᵢ+t_{d}]+D′−t_{d}>tₐ, where t_{d} is the old wait time. Note that the bracketed term contains the deadline used which is equal to D[i]. Therefore t_{d}−D′ equals the minimum of (D[i]−tₐ) over i at all times. This minimum value can be conveniently calculated from the algorithm above. With new and better delays, we run the scheduling program again to come up with a new schedule. Since the new delays must produce a feasible schedule, we will approach an optimal schedule with this feasible schedule.

The Just-In-Time Transmission Algorithm:

An alternative to the EDF schedule is the just-in-time schedule. The just-in-time algorithm schedules each segment i (i=1, 2, . . . , n) to be transmitted as close to its deadline as possible. Channel conflicts involving more than one segment being assigned to the same channel are resolved by moving one of the two segments to an earlier time. In one embodiment, the segment with the larger i is moved because it is broadcast less frequently and therefore requires less bandwidth. We assume that the multimedia presentations are encoded as constant bit-rate data, thus the transmission time equals the playback time. Note that under a variable bit-rate encoding scheme schedules in the following algorithm should be relative to the end of a segment instead of the beginning of a segment.

The main part of the just-in-time scheduling algorithm contains a loop that schedules the broadcast table S[ ] (scheduling table 14 in FIG. 1), and we use a list L[i] (i=1, . . . , n) to remember the proposed (but not committed) schedule time for each segment as well as channel (from m channels):

(1) Initialize the broadcast scheduling table: for each of the n segments, call the find_next_slot subroutine with T=0 and segment index i.

(2) Find segment Vᵢ whose L[i] is the smallest (earliest in time), commit Vᵢ to the scheduling table S[ ] by recording the transmission time, the segment index, and the channel number. Call the find_next_slot subroutine with L[i] and i.

(3) Repeat step (2) until the end of the schedule time is reached.

find_next_slot subroutine:

(1) The next deadline for the segment i at time T is T+tᵢ+t_{d}, where tᵢ is the time at the start of the segment measured from the beginning of the movie; and t_{d} is the specified delay time.

(2) Schedule segment i to be transmitted at t=T+tᵢ+t_{d}. When there are several channels satisfying this condition, choose one at random (say, channel k). Record t and k in L[i].

(3) In case of a collision when the slot is already occupied for all m channels, we need to move one segment from one of the m channels to an earlier time. Let's say that Vⱼ is the segment that has the highest index number among these m channels. To resolve the collision, find the first empty slot before t (let's say at tₑ), and move Vⱼ towards tₑ, one time-slot at a time. At each time-slot (t′) before tₑ, if there is a Vₖ where k>j, replace Vₖ with Vⱼ. If t′>T, set L[j]=t′ and then move Vₖ towards tₑ. If t′<=T, also modify the scheduling table S[ ] to reflect the fact that Vₖ has been replaced by Vⱼ, and then reschedule Vⱼ and Vₖ by calling this same routine. Until we reach tₑ. Now Vᵢ can be scheduled in the slot Vⱼ previously occupied. See FIG. 7 for an illustration of this case.

(4) Scheduling fails if the collisions cannot be resolved (i.e., an empty time slot cannot be found), or no progress is made after a conflict resolution in step (3).

The Hybrid Method

This alternative method combines features of the earliest deadline first (EDF) and just in time (JIT) processes. In the EDF method, the scheduling is determined by the deadline array D by either the earliest deadline or by minimizing waste in bandwidth. Similar to the EDF procedure, the hybrid method also schedules by minimizing deadlines or wasted bandwidth (or, more generally, any cost function associated with the movie segments), but based on a modified array of deadlines L instead of D. A process similar to that used in the JIT process computes L, the array of n modified deadlines.

We recognize that there may be cases when segments cannot all be broadcast in m channels at their deadlines because of potential overlaps among them. Hence, deadlines in L are modifications of D in such a way that they are as close as possible to their real deadlines without conflict.

In order to schedule any movie partition, we need a continuous version of a conflict resolution routine to modify deadlines so they can actually be scheduled. thus, we presume that a segment can be scheduled in m channels, and we find the one with minimal waste in bandwidth given by w(δ, i)=δ/(tᵢ+t_{d}), where δ is the amount the segment must be moved earlier in order to avoid overlapping with other segments already in L. We may also choose to move the existing segment instead of newly inserted one. Each alternative has an associated bandwidth cost. The best choice for a given situation will be the one that minimizes the total bandwidth waste w. Since the deadline in L can actually be scheduled with m channels, these deadlines are more realistic and hopefully produce better overall schedules.

The Periodic Transmission Algorithm

In this section, we discuss yet another alternative scheduling method that performs periodic scheduling so that the broadcasting schedule is repeated every period, Tₚ. The period is optimally integral multiples of the movie length. The most common period is one movie length. In the following discussion we develop heuristic algorithms. We first analyze the required transmitting frequency of each segment, which defines an optimal solution. We then discuss a systematic approach for achieving the optimal solution.

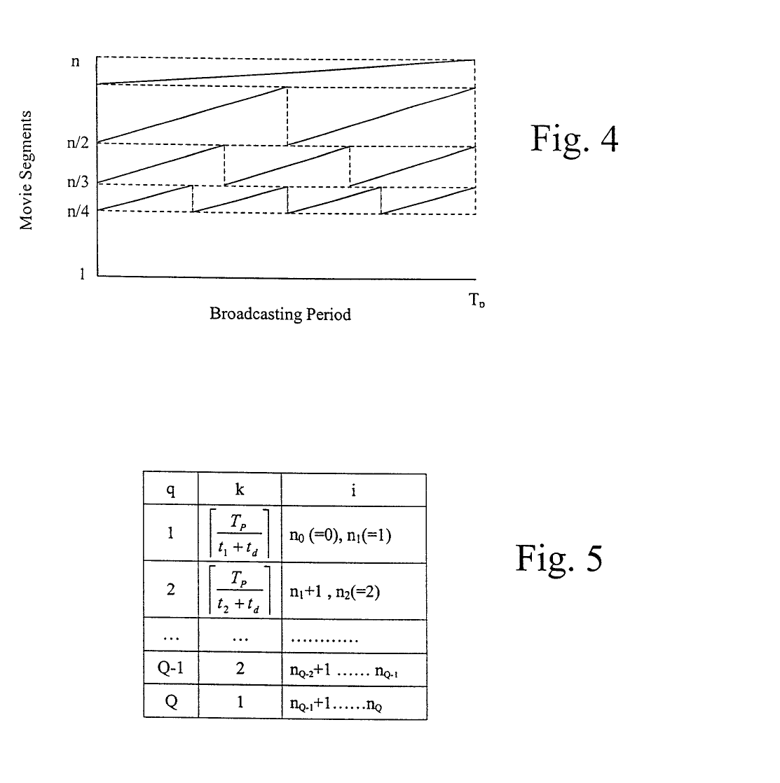

Because of the constraint of periodic scheduling, each segment can be classified according to how many times, k, it must be broadcast in one period Tₚ. FIG. 4 graphically illustrates the broadcasting of segments over different periods in accordance with this scheme. An i-th segment needs to be broadcast

$$k = ⌈ \frac{{T}_{P}}{{t}_{i} + {t}_{d}} ⌉$$

times where ┌ƒ┐ is the smallest integer that is larger than or equal to ƒ. In the above representation, T_{P} is the period of the broadcasting schedule, t_{d} is the delay time and tᵢ is the playback time for segment i.

We create queues labeled by consecutive integers q=1, . . . ,Q. Segments with the same k belong to the same queue. n_{q} demarcates the segments belonging to the same queue: segments in queue q have index i in the range n_{q-1}<i≦n_{q} (n₀ is set to zero). The total number of queues, Q, is equal to the number of distinct integers k for i=1, . . . , n. Note that the integer k may not be consecutive. For example, the first and second segments need to be transmitted

$$⌈ \frac{{T}_{P}}{{t}_{1} + {t}_{d}} ⌉ and ⌈ \frac{{T}_{P}}{{t}_{2} + {t}_{d}} ⌉$$

times, respectively, in one period. (By convention, this defines the first and the second queues, if two integers are different.) These two integers can in general be different and non-consecutive. Note also that many large-i segments belong to the same queue. For example, if the transmission period is one movie length, approximately n/2 of the segments are needed twice in a period. Therefore the total number of queues is much less than n. It is also less than the largest possible

$$k = ⌈ \frac{{T}_{P}}{{t}_{d}} ⌉$$

since k is non-consecutive. FIG. 5 is a schematic illustration of queues that contain the segment indexes used in a periodic transmission scheme in accordance with an embodiment of the present invention.

If a segment cannot be scheduled in a queue (q) with repeat time k, it will be removed from the queue and be placed in the queue with repeat time k+1. If a queue corresponding to k+1 does not exist, a new one is created. Q is incremented by 1, and the queues whose indices are larger than q are all incremented by 1.

The segment, i, is successfully scheduled if the time separation between the repeated broadcasting event is less than tᵢ+t_{d}. Otherwise, the scheduling fails.

In order to facilitate such scheduling, we have the following guidelines:

Schedule the tight deadlines first (the segments with lower index numbers);

Move the block that cannot be scheduled to a lower queue;

Allow local adjustment;

Schedule according to a linear graph in order to ensure the segments are evenly distributed (as illustrated in FIG. 4).

The detailed periodic scheduling algorithm is described as follows

1. Insert each segment i to a queue q according to

$$k = ⌈ \frac{{T}_{P}}{{t}_{i} + {t}_{d}} ⌉ .$$

k is the number of times the segment is broadcast in one period T_{P} and q is a consecutive integer labeling the queue starting from large k. n_{q} is the largest segment index in queue q. Queues are first-in-first-out. Insert the segments starting with small i.

2. Schedule the segments, one from each queue, starting from the largest k. A small value of i denotes a segment that has a tighter deadline.

3. For segment i with n_{q-1}<i≦n_{q} its preferred k time slots are equally spaced and are given by

$${t}_{j} = ⌊ \frac{n}{k} ( \frac{i - {n}_{q - 1}}{{n}_{q} - {n}_{q - 1}} + j ) ⌋ * s ,$$

where j=0, . . . , k−1, s is the segment length in time (assuming they are all the same), and n is the total number of time slots in one broadcasting period. Assign segment i to the scheduling table S[ ] at time tⱼ and choose an available channel from m channels. We can optionally shift all tⱼ periodically by an integer between 0 and n/k in order to minimize crowding around the neighborhood of tⱼ. This is done to make the density of the time slots uniformly distributed around the period.

4. If the preferred time slot is occupied already, search for a nearest empty slot. One constraint must be satisfied: the distance between the adjacent slots must be less than tᵢ+t_{d} including the distance between the first slot and the last one across the period boundary. Scheduling fails if no empty slot satisfies this constraint.

5. If segment i fails to schedule in queue k in step (4), move the segment to the beginning of the queue that repeats k+1 times in a period. Create a queue if necessary, and adjust n_{q} accordingly. If the repeat time k+1 is too large (larger than

$$\vert \frac{{T}_{p}}{{t}_{d}} \vert ) ,$$

scheduling fails, and wait time t_{d} must be increased.

6. Delete the queue from the set if it has run out of the segments.

7. Repeat steps (2) to (6) until all the segments are successfully scheduled.

Re-initialization of n_{q}: if a significant number of segments get moved in step (5), the linear placement relationship in step (3) ceases to be valid. Thus, one should reschedule using the new n_{q}.

By outputting all scheduled segments in each channel into a separate file while preserving relative timing among them, we can make each file into a psudo-movie. We can then provide these peudo-movies to existing head-end transmission systems utilizing multiple channels, and avoid making any changes to the hardware and software configurations of the head-end. Because these files have the periodic property, they can be broadcast repeatedly. The next section addresses transitioning between two movies.

Transitioning Between Two Movies

A practical issue in providing VoD service is accommodating schedule transitions from one movie to the next. The present algorithm-based scheduling method has the flexibility to optimize such transitions.

Assume a first movie finishes at time T_{ƒ}. Any viewer that tuned in before T_{ƒ} is guaranteed to see the entire movie, however, after T_{ƒ} there is no such guarantee. Assume further that the second movie begins at time T_{b}, so that any viewer that tunes in after T_{b} will be able to see the entire second movie. The present algorithms minimize the gap T_{b}−T_{ƒ} and also determines a best feasible gap. In this approach we expect T_{b}−T_{ƒ} to be small, for example on the order of the receiver latency time. A short introduction to the next movie can be played for example.

In the case of the just in time algorithm, a movie transition is implemented in the main loop: After T_{ƒ}, new deadlines need not to be generated after transmission of each segment. At time T_{b}, we acquired a new set of n deadlines for the second movie. These new deadlines are scheduled all at once in the scheduling table. To resolve any conflicts, the first movie segments are assigned a lower priority and so will be moved first. Similarly in earliest deadline first method, the first movie segments transmitted after T_{ƒ} will no longer generate new deadlines. At time T_{b}, a new set of deadlines is generated and competes with the deadlines for the first movie for transmission. In the periodic scheduling approach, the last period of the first movie and the first period of the second movie need to be replaced by a specially designed transition block.

The Receiving Algorithm:

Set-top box 20 implements a receiving algorithm that allows for playback of the requested movie. The algorithm at the receiver is as follows:

1. Let the user select the movie to watch.

2. Tune to the set of channels that carry the segments of the selected movie. These channels should be accessible simultaneously.

3. Start receiving data from these channels immediately. Record and store these segments in a temporary buffer such as receive buffer 24. Between the current time and the specified wait time, the set-top box 20 can play back a pre-stored piece of content or can continue playing out the previously viewed channel information or can play out some other content.

4. After the specified wait time, the first video segment of the requested content will have been received. This content can now be processed for viewing according to the encoding/decoding format used (e.g., MPEG-2). In the mean time, the set-top box 20 continues to receive and store data from the channels of interest.

5. Continuously play back the movie at its original bit-rate while concurrently receiving and storing data until the end of the movie, or until the user requests a pause or stop. During a pause, content can be stored in the receive buffer 24 for later playback.

Thus a scheme for VoD broadcast has been described. Although the foregoing description and accompanying figures discuss and illustrate specific embodiments, it should be appreciated that the present invention is to be measured only in terms of the claims that follow.

What is claimed is:

1. A method, comprising determining a schedule for transmission times of various segments of digital content across multiple channels so as to permit any number of content consumers to begin playback of said segments of digital content from an origination point thereof within a waiting time of a request for such playback.

2. The method of claim 1 wherein the various segments of digital content together comprise a movie.

3. The method of claim 2 wherein the schedule is determined according to an earliest-deadline-first (EDF) process.

4. The method of claim 3 wherein in the EDF process a next transmission time for one of the various segments of digital content is determined by first finding an earliest deadline amongst a list of current deadlines for each of the various segments and selecting this segment for transmission.

5. The method of claim 4 wherein the earliest deadline so chosen is verified to be later than a finishing time for a last transmitted segment.

6. The method of claim 4 wherein a new deadline for transmission of the selected segment is determined according to T+tᵢ+t_{d}, where T is a beginning time for the transmission of the selected segment, i is a segment number for the selected segment, tᵢ is the playback time of segment i and td is the waiting time.

7. The method of claim 2 wherein a cost function is associated with each of the various segments scheduled for transmission, and a segment with the lowest of the cost functions is selected to be transmitted next.

8. The method of claim 7 wherein the cost function comprises wasted bandwidth.

9. The method of claim 2 wherein the schedule is determined according to a just-in-time (JIT) process.

10. The method of claim 9 wherein the JIT process schedules each of the various segments for transmission as close to a transmission deadline associated with each segment as possible.

11. The method of claim 10 wherein in the JIT process, conflicts for transmissions over the multiple channels are resolved by scheduling a segment with an earlier playback time closer to its deadline for transmission than a segment with a later playback time.

12. The method of claim 10 wherein in the JIT process, the transmission deadline associated with a particular one of the segments is determined as a time equal to a current time plus a playback time for that particular one of the segments plus the waiting time.

13. The method of claim 4 wherein in the EDF process, the deadlines associated with the various segments are computed according to a process wherein conflicts for transmissions over the multiple channels are resolved by scheduling a segment with an earlier playback time closer to its deadline for transmission than a segment with a later playback time.

14. The method of claim 2 wherein the schedule is determined according to a periodic transmission process.

15. The method of claim 14 wherein the periodic transmission process allows a broadcast schedule for the movie to be repeated every period time, the period time being equal to an integral multiple of a length of the movie.

16. The method of claim 14 wherein each one of the multiple segments is allocated to a transmission queue number of a transmission schedule table according to a number of times equal to a movie period divided by the sum of the waiting time and a playback time for such one segment.

17. The method of claim 15 wherein all of the segments allocated to a single one of the multiple channels form a pseudo-movie, and all such pseudo-movies for all of the multiple channels are input to multiple channels of a transmission head-end.

18. A method, comprising:
i. dividing a multimedia presentation into sequential segments, each segment having a time length,
ii. scheduling transmission of the segments of the multimedia presentation according to a schedule computed according to a specified delay time that does not depend on the time lengths of the segments, and
iii. transmitting the segments over a broadcast network according to the schedule for each segment computed in step ii.

19. The method of claim 18 wherein a transmission bandwidth of multiple times that of the multimedia presentation is allocated for transmission of the segments and each segment is transmitted repeatedly based on the computed schedule.

20. The method of claim 18 wherein early segments are transmitted more frequently than later segments.

21. The method of claim 18 further comprising receiving the segments transmitted over the broadcast network, storing the segments in temporary storage, and playing back the segments as soon as the delay time has elapsed.

22. A method as in claim 18 wherein each of the segments is scheduled for repeated transmissions at periodic times.

23. A method as in claim 22 wherein the periodic times for transmission of each respective segments equals time offsets of the beginning of such respective segment plus an operator selected delay time.

24. A method as in claim 18 wherein segments having earlier transmission deadlines are scheduled first and as soon as possible.

25. A method as in claim 18 wherein segments are transmitted just-in-time as determined by respective time offsets and the specified delay.

26. A method as in claim 25 wherein in the case of a conflict where more of the segments are to be transmitted than allocated bandwidth allows, segments later in the presentation are scheduled to be transmitted earlier in nearest empty time slots, giving priority to earlier segments to be transmitted as closely as possible to their scheduled time slots.

27. A method as in claim 18 further comprising computing an overlap period between an end of a current presentation and a beginning of a next presentation, to minimize interruptions therebetween.

28. A server configured to generate transmission schedules for each of a number of segments of a multimedia presentation to be transmitted over a multiple channels of a broadcast network, said schedules computed according to a specified delay time that does not depend on time lengths of the segments.

29. The server of claim 28 wherein the transmission schedules are computed according to one of a just-in-time transmission (JIT) procedure, an earliest-deadline-first (EDF) procedure or a periodic transmission procedure.

30. The server of claim 29 wherein according to the EDF procedure a next segment to be transmitted is determined by first finding an earliest transmission deadline amongst a list of current transmission deadlines for each of the segments and selecting this segment for transmission.

31. The server of claim 29 wherein according to the JIT procedure each of the segments are scheduled for transmission as close to a transmission deadline associated with each segment as possible.

32. The server of claim 29 wherein according to the periodic transmission procedure each of the segments is allocated to a transmission queue according to a schedule that takes into account a period of the presentation, the delay time and a playback time for each segment.

33. A receiver configured to receive segments of multimedia presentation from multiple transmission channels simultaneously and to begin playback of the segments in a sequence corresponding to a proper format for the multimedia presentation after a predetermined delay time that is independent of time lengths of the segments.

34. The receiver of claim 33 wherein the segments are stored on a local storage medium.

35. The receiver of claim 33 wherein the segments are received according to a schedule that was computed according to one of a just-in-time transmission (JIT) procedure, an earliest-deadline-first (EDF) procedure, a combination of aspects of the EDF and JIT procedures, or a periodic transmission procedure.
